(19) United States
(12) Patent Application Publication
(10) Pub. No.: US 2015/0077552 A1
(43) Pub. Date: Mar. 19, 2015

(54) HEAD MOUNTED SYSTEM

(71) Applicant: Quanta Computer Inc., Tao Yuan Shien (TW)

(72) Inventors: Wen-Chu YANG, New Taipei City (TW); Chung-Te LI, New Taipei City (TW)

(73) Assignee: Quanta Computer Inc., Tao Yuan Shien (TW)

(21) Appl. No.: 14/134,299

(22) Filed: Dec. 19, 2013

(30) Foreign Application Priority Data
Sep. 13, 2013 (TW) 102133271

(51) Int. Cl. H04N 5/225; H04N 7/18

(52) U.S. Cl. CPC H04N 5/2252; H04N 7/18
USPC 348/143

(57) ABSTRACT

A head mounted system is provided. The head mounted system includes an auxiliary image capturing device, a main image capturing device, a signal processing circuit, a memory, an application processor, and an eyeglass frame. The auxiliary image capturing device detects an abnormal situation. The signal processing circuit outputs a warning signal and makes the main image capturing device start video recording when the abnormal situation occurs. The application processor receives the warning signal and stores video data, after the video recording starting, in the memory. The eyeglass frame carries the auxiliary image capturing device, the main image capturing device, the signal processing circuit, the memory, and the application processor.

This application claims the benefit of Taiwan application Serial No. 102133271, filed Sep. 13, 2013, the subject matter of which is incorporated herein by reference.

### TECHNICAL FIELD

The invention relates in general to an electronic device, and more particularly to a head mounted system.

### BACKGROUND

As technology progresses, people receive more information from electronic devices, such as multimedia players, network communication devices, and computers, which are equipped with display devices such as CRTs or LCDs for displaying images. The number of pixels and size of the image displayed by the display devices are constrained by the size of the display devices and their performance. Hence, the conventional CRT or LCD displays cannot meet the requirement of compact, portability, and a size with high display quality. For resolving this problem, the head-mounted display (HMD) is provided in the market. The head-mounted display provides two small tubes or LCDs disposed in front of the left and right eyes of a person. For example, a head-mounted display achieves stereoscopic effects by using binocular parallax, which projects images outputted from the tubes or LCDs through beam splitters onto the eyes of the user.

### SUMMARY

The disclosure is directed to a head mounted system.

According to an embodiment, a head mounted system is provided. The head mounted system includes an abnormality sensing unit, a plurality of image capturing devices, a signal processing circuit, a memory, an application processor, and an eyeglass frame. The abnormality sensing unit detects an abnormal situation. The signal processing circuit outputs a warning signal and makes at least one of the image capturing devices start video recording when the abnormal situation occurs. The application processor receives the warning signal and storing video data, after the video recording is started, in the memory. The eyeglass frame carries the abnormality sensing unit, the image capturing devices, the signal processing circuit, the memory, and the application processor.

According to another embodiment, a head mounted system is provided. The head mounted system includes an auxiliary image capturing device, a main image capturing device, a signal processing circuit, a memory, an application processor, and an eyeglass frame. The auxiliary image capturing device detects an abnormal situation. The signal processing circuit outputs a warning signal and makes the main image capturing device start video recording when the abnormal situation occurs. The application processor receives the warning signal and stores video data, after the video recording starting, in the memory. The eyeglass frame carries the auxiliary image capturing device, the main image capturing device, the signal processing circuit, the memory, and the application processor.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a head mounted system according to a first embodiment.

FIG. 2 is a diagram illustrating a head mounted system according to the first embodiment.

FIG. 3 is a block diagram of a head mounted system according to a second embodiment.

FIG. 4 is a diagram illustrating a head mounted system according to the second embodiment.

FIG. 5 is a flowchart of capturing a first side image according to the second embodiment.

FIG. 6 is a flowchart of capturing a first rear image and a second rear image according to the second embodiment.

FIG. 7 is a diagram illustrating a head mounted system according to a third embodiment.

FIG. 8 is a diagram illustrating a head mounted system according to a fourth embodiment.

### DETAILED DESCRIPTION

### First Embodiment

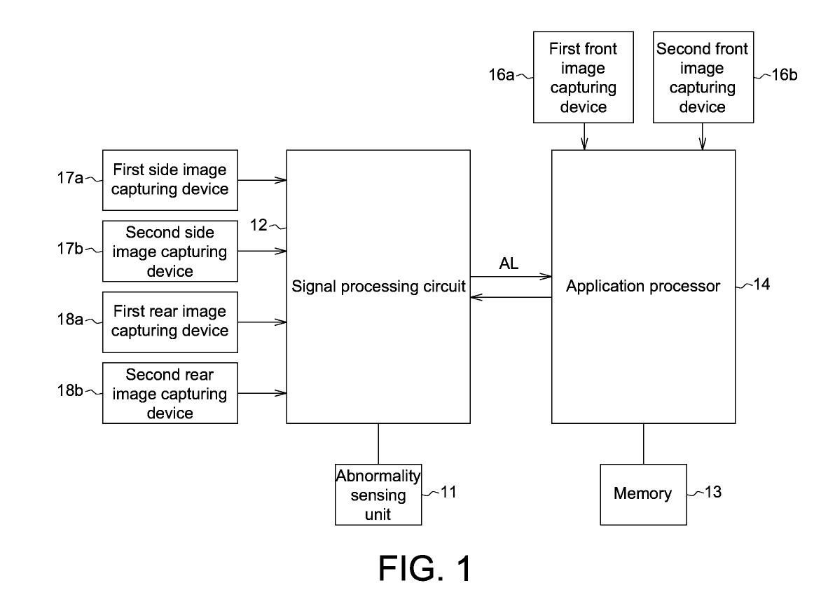

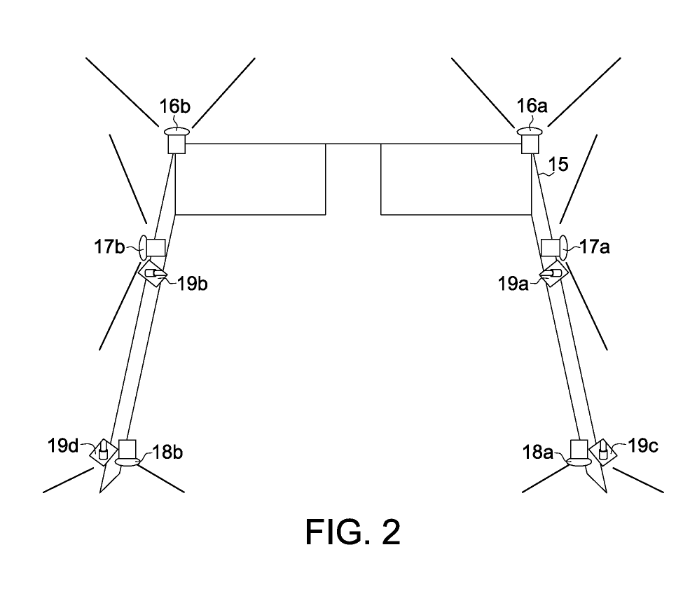

Referring to FIGS. 1 and 2, FIG. 1 is a block diagram of a head mounted system according to a first embodiment, and FIG. 2 is a diagram illustrating a head mounted system according to the first embodiment. A head mounted system 1 is a head-mounted display (HMD), for example. The head mounted system 1 includes an abnormality sensing unit 11, a signal processing circuit 12, a memory 13, an application processor 14, an eyeglass frame 15, a first front image capturing device 16a, a second front image capturing device 16b, a first side image capturing device 17a, a second side image capturing device 17b, a first rear image capturing device 18a, a second rear image capturing device 18b, a first infrared light emitting diode (LED) 19a, a second infrared LED 19b, a third infrared LED 19c, and a fourth infrared LED 19d. The abnormality sensing unit 11, for example, is a microphone or an auxiliary image capturing device. The eyeglass frame 15 is used for carrying the abnormality sensing unit 11, the signal processing circuit 12, the memory 13, application processor 14, the first front image capturing device 16a, the second front image capturing device 16b, the first side image capturing device 17a, the second side image capturing device 17b, the first rear image capturing device 18a, the second rear image capturing device 18b, the first infrared LED 19a, second infrared LED 19b, the third infrared LED 19c, and the fourth infrared LED 19d.

The signal processing circuit 12, for example, is an application-specific integrated circuit (ASIC), and the signal processing circuit 12 communicates with the application processor 14 through a universal serial bus (USB). The first front image capturing device 16a and the second front image capturing device 16b are connected to the application processor 14 and communicate with the application processor 14 through a mobile interface processor interface (MIPI). The first side image capturing device 17a, the second side image capturing device 17b, the first rear image capturing device 18a, and the second rear image capturing device 18b are connected to the signal processing circuit 12, and communicate with the signal processing circuit 12 through a parallel interface (I/F) or MIPI.

The first front image capturing device 16a, disposed in the front of the eyeglass frame 15, is used for capturing a first front image, and the second front image capturing device 16b, disposed in the front of the eyeglass frame 15, is used for capturing a second front image. The viewing angles of the first front image capturing device 16a and the second front image capturing device 16b coincide with those of the human eyes. The first side image capturing device 17a, disposed in a first side of the eyeglass frame 15, is used for capturing a first side image. The second side image capturing device 17b, disposed in a second side of the eyeglass frame 15, is employed for capturing a second side image. The first side is a right side, for example, and the second side is a left side, for example. The viewing angles of the first side image capturing device 17a and the second side image capturing device 17b are different from those of the first front image capturing device 16a and the second front image capturing device 16b. The first rear image capturing device 18a, disposed in a rear of the eyeglass frame 15, is used for capturing a first rear image. The second rear image capturing device 18b, disposed in the rear of the eyeglass frame 15, is used for capturing a second rear image. The viewing angles of the first rear image capturing device 18a and the second rear image capturing device 18b are different from those of the first side image capturing device 17a and the second side image capturing device 17b.

The first front image capturing device 16a, the second front image capturing device 16b, the first side image capturing device 17a, the second side image capturing device 17b, the first rear image capturing device 18a and the second rear image capturing device 18b can cover the blind spot of human eyes. The viewing angles of the first front image capturing device 16a, the second front image capturing device 16b, the first side image capturing device 17a, the second side image capturing device 17b, the first rear image capturing device 18a, and the second rear image capturing device 18b can cover 360 degrees.

The first infrared LED 19a is disposed adjacent to the first side image capturing device 17a, and the second infrared LED 19b is disposed adjacent to the second side image capturing device 17b. The third infrared LED 19c is disposed adjacent to the first rear image capturing device 18a, and the fourth infrared LED 19d is disposed adjacent to the second rear image capturing device 18b. The first infrared LED 19a, second infrared LED 19b, third infrared LED 19c, and the fourth infrared LED 19d are employed to provide auxiliary light.

The abnormality sensing unit 11 detects an abnormal situation. When the abnormal situation occurs, the signal processing circuit 11 outputs a warning signal AL to the application processor 14, and makes at least one of the first front image capturing device 16a, the second front image capturing device 16b, the first side image capturing device 17a, the second side image capturing device 17b, the first rear image capturing device 18a, and the second rear image capturing device 18b start video recording. The application processor 14 receives the warning signal, and stores video data, after the video recording is started, in the memory 13.

For the sake of illustration, the abnormality sensing unit 11 is implemented by a microphone, for example. The microphone senses an ambient sound. When the ambient sound is greater than a threshold, it is indicated that an abnormal situation occurs. The signal processing circuit 12 outputs a warning signal AL to the application processor 14, and makes the first front image capturing device 16a, the second front image capturing device 16b, the first side image capturing device 17a, the second side image capturing device 17b, the first rear image capturing device 18a, and the second rear image capturing device 18b start video recording. For example, when a vehicle, such as a motorcycle or car, honks its horn loudly, the ambient sound may be greater than the threshold.

### Second Embodiment

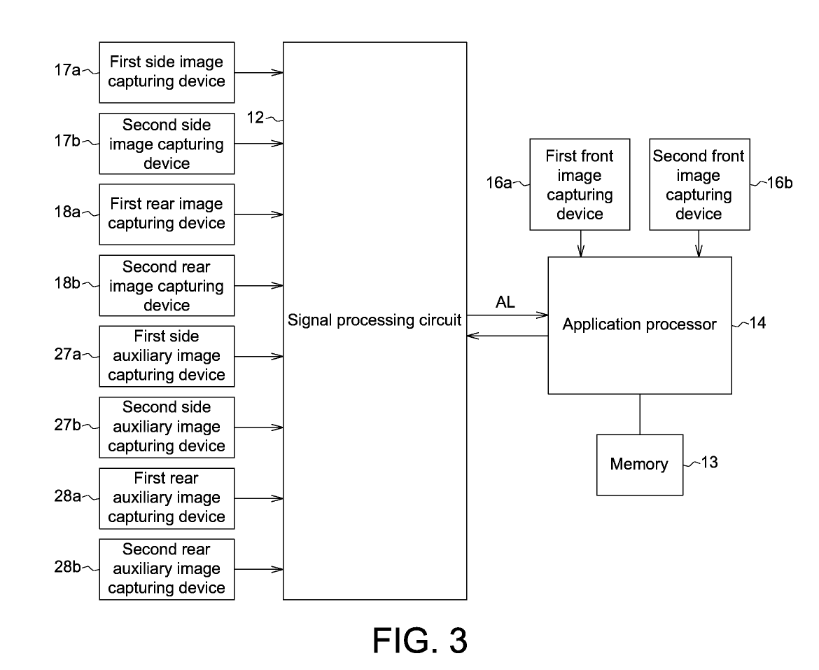

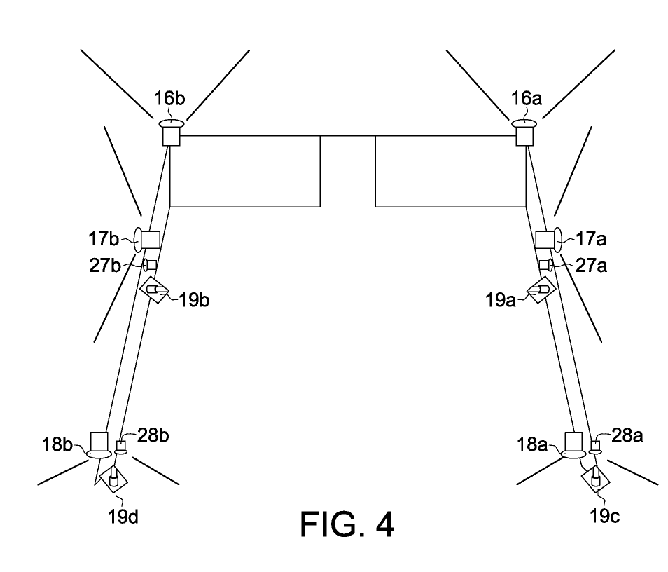

Referring to FIGS. 3 and 4, FIG. 3 is a block diagram of a head mounted system according to a second embodiment, and FIG. 4 is a diagram illustrating a head mounted system according to the second embodiment. The second embodiment differs from the first embodiment in that an abnormality sensing unit of the head mounted system 2 is exemplified by using a first side auxiliary image capturing device 27a, a second side auxiliary image capturing device 27b, a first rear auxiliary image capturing device 28a, and a second rear auxiliary image capturing device 28b. The first side auxiliary image capturing device 27a is disposed adjacent to the first side image capturing device 17a. The second side auxiliary image capturing device 27b is disposed adjacent to the second side image capturing device 17b. The first rear auxiliary image capturing device 28a is disposed adjacent to the first rear image capturing device 18a, and the second rear auxiliary image capturing device 28b is disposed adjacent to the second rear image capturing device 18b.

The first side auxiliary image capturing device 27a, the second side auxiliary image capturing device 27b, the first rear auxiliary image capturing device 28a, and the second rear auxiliary image capturing device 28b capture ambient images. The signal processing circuit 12 determines whether an object is fast approaching according to the ambient images. When the object is fast approaching, it is indicated that the abnormal situation occurs.

It is noticed that the first side auxiliary image capturing device 27a, the second side auxiliary image capturing device 27b, the first rear auxiliary image capturing device 28a, and the second rear auxiliary image capturing device 28b are auxiliary image capturing devices. The first front image capturing device 16a, the second front image capturing device 16b, the first side image capturing device 17a, the second side image capturing device 17b, the first rear image capturing device 18a, and the second rear image capturing device 18b are main image capturing devices. The power consumption of the auxiliary image capturing devices is less than that of the main image capturing devices.

For example, the resolutions of the first side auxiliary image capturing device 27a, the second side auxiliary image capturing device 27b, the first rear auxiliary image capturing device 28a, and the second rear auxiliary image capturing device 28b are less than those of the first front image capturing device 16a, the second front image capturing device 16b, the first side image capturing device 17a, the second side image capturing device 17b, the first rear image capturing device 18a, and the second rear image capturing device 18b. Alternatively, the image capturing frequencies of the first side auxiliary image capturing device 27a, the second side auxiliary image capturing device 27b, the first rear auxiliary image capturing device 28a, and the second rear auxiliary image capturing device 28b are less than those of the first front image capturing device 16a, the second front image capturing device 16b, the first side image capturing device 17a, the second side image capturing device 17b, the first rear image capturing device 18a, and the second rear image capturing device 18b. In this way, the power consumption of the first side auxiliary image capturing device 27a, the second side auxiliary image capturing device 27b, the first rear auxiliary image capturing device 28a, and the second rear auxiliary image capturing device 28b may be less than that of the first front image capturing device 16a, the second front image capturing device 16b, the first side image capturing device 17a, the second side image capturing device 17b, the first rear image capturing device 18a, and the second rear image capturing device 18b, thus leading to a reduced power consumption for the system.

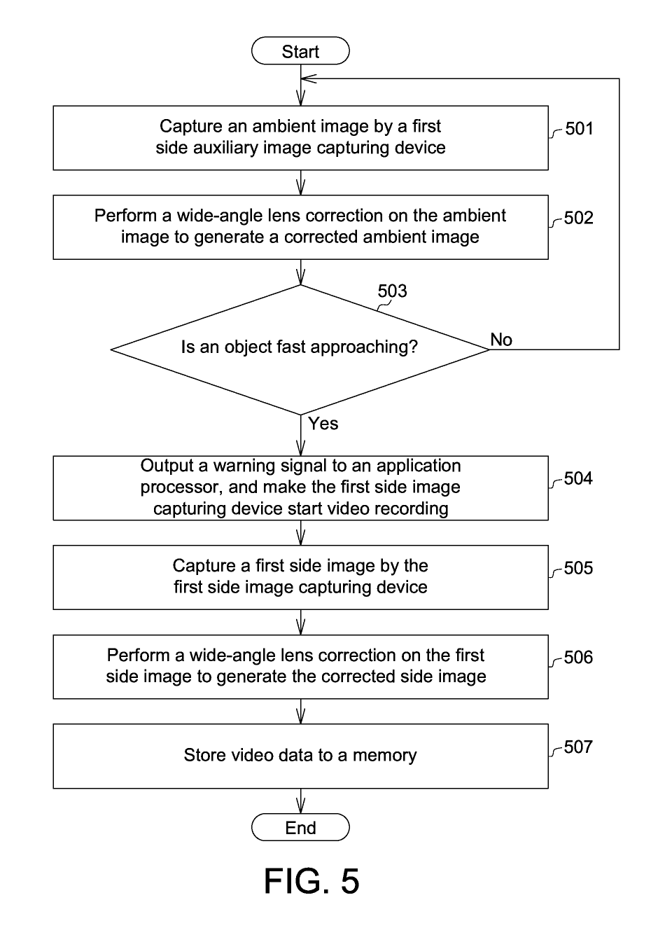

Referring to FIGS. 3 and 5, FIG. 5 is a flowchart of capturing a first side image according to the second embodiment. For the sake of illustration, FIG. 5 illustrates capturing the first side image as an example. First, in step 501, the first side auxiliary image capturing device 27a captures an ambient image, wherein the power consumption of the first side auxiliary image capturing device 27a is less than that of the first side image capturing device 17a. In step 502, the signal processing circuit 12 then performs a wide-angle lens correction on the ambient image to generate a corrected ambient image. After that, in step 503, the signal processing circuit 12 determines whether an object is fast approaching according to the corrected ambient image. If no object is fast approaching, it is indicated that no abnormal situation occurs and step 501 is performed again.

Conversely, if an object is fast approaching, it is indicated that the abnormal situation occurs. As shown in step 504, the signal processing circuit 12 outputs a warning signal AL to the application processor 14, and the application processor 14, for example, may inform the user of the abnormal situation through a user interface. The user interface may be implemented by using a display device or a sound reproduction device. The signal processing circuit 12 makes the first side image capturing device 17a start video recording. In step 505, the first side image capturing device 17a then captures a first side image. In step 506, the signal processing circuit 12 performs a wide-angle lens correction on the first side image to generate a corrected side image. After that, in step 507, the application processor 14 stores video data in the memory 13, and the video data includes the corrected side image.

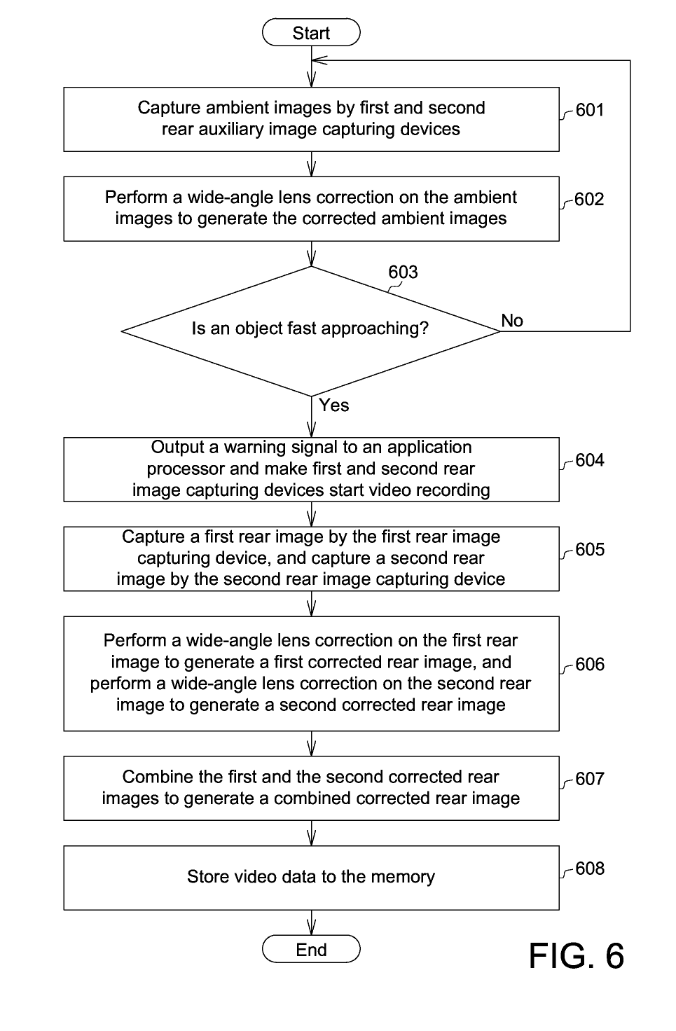

Referring to FIGS. 3 and 6, FIG. 6 is a flowchart of capturing a first rear image and a second rear image according to the second embodiment. First, in step 601, the first rear auxiliary image capturing device 28a and the second rear auxiliary image capturing device 28b capture ambient images. The power consumption of the first rear auxiliary image capturing device 28a is less than that of the first rear image capturing device 18a, and the power consumption of the second rear auxiliary image capturing device 28b is less than that of the second rear image capturing device 18b. In step 602, the signal processing circuit 12 then performs a wide-angle lens correction on the ambient images to generate the corrected ambient image. After that, in step 603, the signal processing circuit 12 determines whether an object is fast approaching according to the corrected ambient images. If no object is fast approaching, it is indicated that no abnormal situation occurs and step 601 is performed again.

Conversely, if an object is fast approaching, step 604 is performed. As shown in step 604, the signal processing circuit 12 outputs a warning signal AL to the application processor 14, and the application processor 14, for example, may inform the user of the abnormal situation through a user interface. The user interface may be implemented by using a display device or a sound reproduction device. The signal processing circuit 12 makes the first rear image capturing device 18a and the second rear image capturing device 18b start video recording. In step 605, the first rear image capturing device 18a captures a first rear image, and the second rear image capturing device 18b captures a second rear image. In step 606, the signal processing circuit 12 performs a wide-angle lens correction on the first rear image to generate a first corrected rear image, and performs a wide-angle lens correction on the second rear image to generate a second corrected rear image. In step 607, the signal processing circuit 12 combines the first corrected rear image and the second corrected rear image to generate a combined corrected rear image; this process is also called image stitching. After that, in step 608, the application processor 14 stores video data in the memory 13, and the video data includes the combined corrected rear image.

Specifically, when the auxiliary image capturing device detects an abnormal situation, the signal processing circuit 12 makes not only the main image capturing device adjacent to the signal processing circuit 12 start video recording, but also other main image capturing devices start video recording. For example, when the first side auxiliary image capturing device 27a detects that an abnormal situation occurs, the signal processing circuit 12 makes not only the first side image capturing device 17a start video recording, but also the first front image capturing device 16a and the second front image capturing device 16b start video recording.

In addition, the abnormality sensing unit of the head mounted system 2 may further include a microphone. When the microphone detects the abnormal situation, the signal processing circuit 11 outputs a warning signal AL to the application processor 14, and makes at least one of the first front image capturing device 16a, the second front image capturing device 16b, the first side image capturing device 17a, the second side image capturing device 17b, the first rear image capturing device 18a, and the second rear image capturing device 18b start video recording. The application processor 14 receives the warning signal and stores the video data in the memory 13 after the video recording is started.

### Third Embodiment

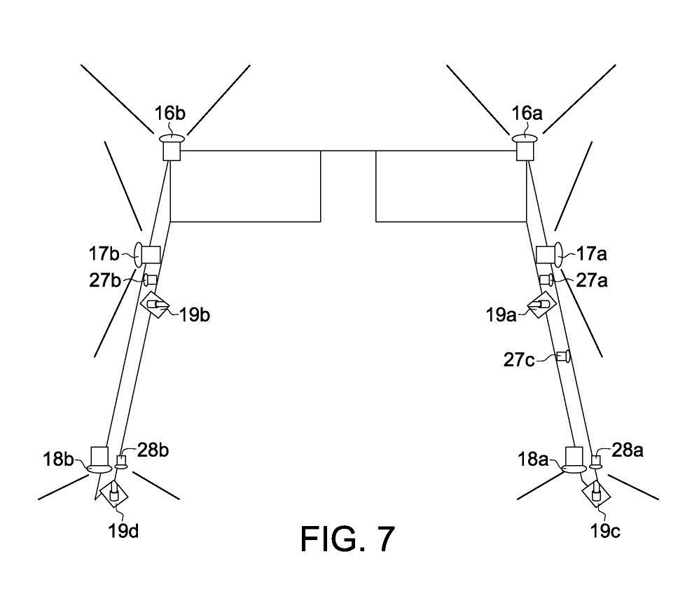

Referring to FIGS. 3 and 7, FIG. 7 is a diagram illustrating a head mounted system according to a third embodiment. The third embodiment differs from the second embodiment in that the abnormality sensing unit of a head mounted system 3 includes a third side auxiliary image capturing device 27c, which is an auxiliary image capturing device. The third side auxiliary image capturing device 27c and the first side image capturing device 17a are disposed on a first side of the eyeglass frame 15, and the power consumption of the third side auxiliary image capturing device 27c is less than that of the first side image capturing device 17a.

It is noticed that the arrangement of the auxiliary image capturing device and the main image capturing device may be one to one, but the implementation is not limited thereto. In another embodiment, a plurality of auxiliary image capturing devices may be accompanied with a main image capturing device. In yet another embodiment, an auxiliary image capturing device may be accompanied with a plurality of main image capturing devices. As shown in FIG. 7, the third side auxiliary image capturing device 27c and the first side auxiliary image capturing device 27a are accompanied with the first side image capturing device 17a. When the third side auxiliary image capturing device 27c and the first side auxiliary image capturing device 27a detect that an abnormal situation occurs, the signal processing circuit outputs a warning signal and makes the first side image capturing device 17a start video recording.

In addition, the abnormality sensing unit of the head mounted system 3 may further include a microphone. When the microphone detects the abnormal situation, the signal processing circuit 11 outputs a warning signal AL to the application processor 14, and makes at least one of the first front image capturing device 16a, the second front image capturing device 16b, the first side image capturing device 17a, the second side image capturing device 17b, the first rear image capturing device 18a, and the second rear image capturing device 18b start video recording. The application processor 14 receives the warning signal, and stores the video data in the memory 13 after the video recording is started.

### Fourth Embodiment

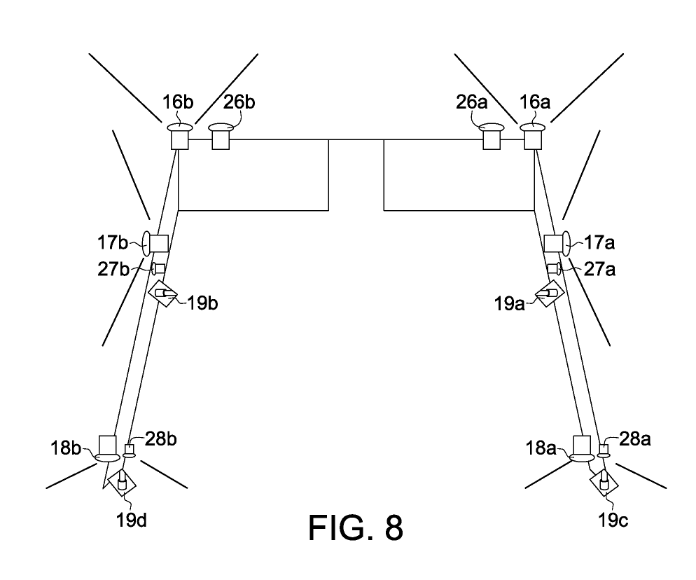

Referring to FIGS. 3 and 8, FIG. 8 is a diagram illustrating a head mounted system according to a fourth embodiment. The fourth embodiment differs from the second embodiment in that the abnormality sensing unit of a head mounted system 4 further includes a first front auxiliary image capturing device 26a and a second front auxiliary image capturing device 26b. The first front auxiliary image capturing device 26a is disposed adjacent to the first front image capturing device 16a, and the second front auxiliary image capturing device 26b is disposed adjacent to the second front image capturing device 16b.

In addition, the abnormality sensing unit of the head mounted system 4 may further include a microphone. When the microphone detects the abnormal situation, the signal processing circuit 11 outputs a warning signal AL to the application processor 14, makes at least one of the first front image capturing device 16a, the second front image capturing device 16b, the first side image capturing device 17a, the second side image capturing device 17b, the first rear image capturing device 18a, and the second rear image capturing device 18b start video recording. The application processor 14 receives the warning signal and stores the video data in the memory 13 after the video recording is started.

The above embodiments provide a head mounted system that can warn the user to protect oneself when an abnormal situation occurs. In addition, when an abnormal situation occurs, the head mounted system can start video recording to record the evidence of the scene. In addition, an extended time for self-protection with reduced power consumption can be achieved since the power consumption of the abnormality sensing unit is less than that of the main image capturing device and the main image capturing device is activated as an abnormal situation occurs.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A head mounted system, comprising:
an abnormality sensing unit for detecting an abnormal situation;
a plurality of image capturing devices;
a signal processing circuit, for outputting a warning signal and making at least one of the image capturing devices start video recording when the abnormal situation occurs;
a memory;
an application processor for receiving the warning signal and storing video data, after the video recording is started, in the memory; and
an eyeglass frame for carrying the abnormality sensing unit, the image capturing devices, the signal processing circuit, the memory, and the application processor.

2. The head mounted system according to claim 1, wherein the abnormality sensing unit comprises a plurality of auxiliary image capturing devices for capturing a plurality of ambient images; the signal processing circuit determines whether any object is fast approaching according to the ambient images; when an object is fast approaching, it is indicated that the abnormal situation occurs.

3. The head mounted system according to claim 2, wherein power consumption of the auxiliary image capturing devices is less than that of the image capturing devices.

4. The head mounted system according to claim 2, wherein resolutions of the auxiliary image capturing devices are smaller than those of the image capturing devices.

5. The head mounted system according to claim 2, wherein image capturing frequencies of the auxiliary image capturing devices are less than those of the image capturing devices.

6. The head mounted system according to claim 2, wherein the image capturing devices include:
a first front image capturing device, disposed in a front of the eyeglass frame, for capturing a first front image;
a first side image capturing device, disposed in a first side of the eyeglass frame, for capturing a first side image; and
a first rear image capturing device, disposed in a rear of the eyeglass frame, for capturing a first rear image.

7. The head mounted system according to claim 6, wherein the video data includes a corrected side image, the signal processing circuit performs a wide-angle lens correction on the first side image to generate the corrected side image.

8. The head mounted system according to claim 7, wherein the image capturing devices further include:
a second front image capturing device, disposed in the front of the eyeglass frame, for capturing a second front image;
a second side image capturing device, disposed in a second side of the eyeglass frame, for capturing a second side image; and
a second rear image capturing device, disposed in the rear of the eyeglass frame, for capturing a second rear image.

9. The head mounted system according to claim 8, further comprising:
a first infrared light emitting diode, disposed adjacent to the first side image capturing device;
a second infrared light emitting diode, disposed adjacent to the second side image capturing device;
a third infrared light emitting diode, disposed adjacent to the first rear image capturing device; and
a fourth infrared light emitting diode, disposed adjacent to the second rear image capturing device.

10. The head mounted system according to claim 8, wherein the video data includes a combined rear image, the signal processing circuit performs a wide-angle lens correction on the first rear image and the second rear image to generate a first corrected rear image and a second corrected rear image, and the signal processing circuit combines the first corrected rear image and the second corrected rear image to generate the combined rear image.

11. The head mounted system according to claim 8, wherein the auxiliary image capturing devices include:
a first side auxiliary image capturing device, disposed adjacent to the first side image capturing device;
a second side auxiliary image capturing device, disposed adjacent to the second side image capturing device;
a first rear auxiliary image capturing device, disposed adjacent to the first rear image capturing device; and
a second rear auxiliary image capturing device, disposed adjacent to the second rear image capturing device.

12. The head mounted system according to claim 8, wherein the auxiliary image capturing devices include:
a first front auxiliary image capturing device, disposed adjacent to the first front image capturing device;
a second front auxiliary image capturing device, disposed adjacent to the second front image capturing device;
a first side auxiliary image capturing device, disposed adjacent to the first side image capturing device;
a second side auxiliary image capturing device, disposed adjacent to the second side image capturing device;
a first rear auxiliary image capturing device, disposed adjacent to the first rear image capturing device; and
a second rear auxiliary image capturing device, disposed adjacent to the second rear image capturing device.

13. The head mounted system according to claim 8, wherein the auxiliary image capturing devices further include:
a third side auxiliary image capturing device, disposed on the first side of the eyeglass frame.

14. The head mounted system according to claim 1, wherein the abnormality sensing unit comprises a microphone for sensing an ambient sound; and when the ambient sound is greater than a threshold, it is indicated that the abnormal situation occurs.

15. The head mounted system according to claim 1, wherein the image capturing devices include:
a first front image capturing device, disposed in a front of the eyeglass frame, for capturing a first front image;
a first side image capturing device, disposed in a first side of the eyeglass frame, for capturing a first side image; and
a first rear image capturing device, disposed in a rear of the eyeglass frame, for capturing a first rear image.

16. The head mounted system according to claim 15, wherein the image capturing devices further include:
a second front image capturing device, disposed in the front of the eyeglass frame, for capturing a second front image;
a second side image capturing device, disposed in a second side of the eyeglass frame, for capturing a second side image; and
a second rear image capturing device, disposed in the rear of the eyeglass frame, for capturing a second rear image.

17. A head mounted system, comprising:
an auxiliary image capturing device for detecting an abnormal situation;
a main image capturing device;
a signal processing circuit, for outputting a warning signal and making the main image capturing device start video recording when the abnormal situation occurs;
a memory;
an application processor for receiving the warning signal and storing video data, after the video recording starting, in the memory; and
an eyeglass frame for carrying the auxiliary image capturing device, the main image capturing device, the signal processing circuit, the memory, and the application processor.

18. The head mounted system according to claim 17, wherein power consumption of the auxiliary image capturing device is less than that of the main image capturing device.

19. The head mounted system according to claim 17, wherein a resolution of the auxiliary image capturing device is less than that of the main image capturing device.

20. The head mounted system according to claim 17, wherein an image capturing frequency of the auxiliary image capturing device is less than that of the main image capturing device.
